(19) United States
(12) Patent Application Publication
(10) Pub. No.: US 2026/0145873 A1
(43) Pub. Date: May 28, 2026

(54) A CONTAINER TRANSPORT VEHICLE WITH INTERNAL RECEIVING SPACE FOR RECEIVING A STORAGE CONTAINER FROM ANOTHER VEHICLE, ASSOCIATED SYSTEM AND METHODS

(71) Applicant: AutoStore Technology AS, Nedre Vats (NO)

(72) Inventor: Jørgen Djuve Heggebø, Langhus (NO)

(21) Appl. No.: 19/121,974

(22) PCT Filed: Oct. 12, 2023
(86) PCT No.: PCT/EP2023/078358

§ 371 Date: Apr. 17, 2025

(30) Foreign Application Priority Data
Oct. 18, 2022 (NO) 20221114

(51) Int. Cl. B65G 1/04; B61B 5/02; B61C 13/04; B65G 1/06

(52) U.S. Cl. CPC B65G 1/0464; B61B 5/02; B61C 13/04; B65G 1/065

(57) ABSTRACT

It is described a container transport vehicle (501′; 501″; 501′″; 501″″,501′″) for operation on a rail system (108) of an automated storage and retrieval system (1), the container transport Y vehicle (501′,501″,501′″; 501″″; 501′″) comprising:—a vehicle body (501a′; 501a″; 501a′″; 501a″″; 501a′″″) defining a vehicle base (501d), four sides (501e), and an upper face (501f′; 501f″) opposite the vehicle base (501d);—a first drive means (501b) for movement of the container transport vehicle (501′,501″; 501′″,501″″; 501′″″) in a first direction (X);—a second drive means (501c) for movement of the container transport vehicle (501′; 501″,501′″; 501″″;501′″″) in a second direction (Y), wherein the second direction (Y) is perpendicular to the first direction (X);—an internal receiving space (20) within the vehicle body (501a′; 501a″;501a′″;501a″″; 501a′″″);—an elevator assembly (10) comprising a first support surface (11) being vertically movable and configured to support a storage container (106);—wherein the vehicle base (501d ) comprises a base opening (502), and at least one of the sides 501b (501e) comprises a side opening (503), the side opening (503) allowing passage of a storage container (106) into the internal receiving space (20) and the base opening (502) allowing the elevator assembly (10) to lower a storage container (106) at least partly therethrough. It is further described an associated system comprising the container transport vehicle and methods of using the container transport vehicle to transfer storage containers between different locations on a rail system.

The invention relates to a container transport vehicle for operation on a rail system of an automated storage and retrieval system. The container transport vehicle comprises an internal receiving space and a side opening allowing passage of a storage container into and out of the internal receiving space, an elevator assembly comprising a first support surface being vertically movable and configured to support a storage container and lower a storage container at least partly through a base opening of the container transport vehicle.

It is further described an automated storage and retrieval system and methods.

### BACKGROUND AND PRIOR ART

FIG. 1 discloses a prior art automated storage and retrieval system 1 with a frame structure 100 and FIGS. 2, 3 and 4 disclose three different prior art container handling vehicles 201,301,401 suitable for operating on such a system 1.

The frame structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The frame structure 100 of the automated storage and retrieval system 1 comprises a rail system 108 arranged across the top of frame structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of parallel rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the frame structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set of parallel rails 110, and the second set of wheels 201c,301c,401c is arranged to engage with two adjacent rails of the second set of parallel rails 111. At least one of the sets of wheels 201b, 201c, 301b,301c,401b,401c can be lifted and lowered, so that the first set of wheels 201b,301b,401b and/or the second set of wheels 201c,301c,401c can be engaged with the respective set of parallel rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown. The lifting device may comprise a lifting frame 404d suspended from lifting bands 404a. The lifting bands 404a may provide power and communication between the container handling vehicle and the lifting frame 404d. The lifting frame 404d may comprise gripping engaging devices/grippers 404b for connection to gripping recesses of a storage container 106. Guide pins 404c assist in aligning the grippers 404b relative the gripping recesses of the storage container 106.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the frame structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 (showing a cavity-type container handling vehicles) and as described in e.g. WO2015/193278A1 and WO2019/206487A1, the contents of which are incorporated herein by reference.

FIG. 3 shows an alternative configuration of a container handling vehicle 301 with a cantilever construction (referred to as a cantilever-type container handling vehicle). Such a vehicle is described in detail in e.g. NO317366, the contents of which are also incorporated herein by reference.

The cavity-type container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity-type container handling vehicles 401 shown in FIGS. 4 and 5 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the frame structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the frame structure 100 or transferred out of or into the frame structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the frame structure 100, then picked up by any container handling vehicle and transported to a port column 119,120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a drop-off port column where the container handling vehicles 201,301,401 can drop off storage containers 106 to be transported to an access or a transfer station, and the second port column 120 may be a pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the frame structure 100 again once accessed. A port can also be used for transferring storage containers to another storage facility (e.g. to another frame structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different frame structures, e.g. as is described in WO2014/075937A1, the contents of which are incorporated herein by reference.

A storage system may also use port columns 119,120 to transfer a storage container between the rail system 108 on top of the frame structure 100 and a container transfer vehicle arranged below a lower end of the port column. Such storage systems and suitable container transfer vehicles are disclosed in WO 2019/238694 A1 and WO 2019/238697 A1, the contents of which are incorporated herein by reference.

A potential disadvantage of using a container transfer vehicle to retrieve and deliver storage containers from/to the lower end of a port column is the time dependency between the container transfer vehicle(s) and the container handling vehicles used to retrieve/deliver the storage containers through the port column.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device 116, and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the frame structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

An objective of at least embodiments of the invention is to provide a solution for faster transport of a storage container carried by a container handling vehicle from position A to position B on a rail system of an automated storage and retrieval system.

### SUMMARY OF THE INVENTION

The present invention is set forth and characterized in the independent claims, while the dependent claims describe other optional features.

The present invention relates to a container transport vehicle for operation on a rail system of an automated storage and retrieval system, the container transport vehicle comprising:
a vehicle body defining a vehicle base, four sides, and an upper face opposite the vehicle base;
a first drive means for movement of the container transport vehicle in a first direction;
a second drive means for movement of the container transport vehicle in a second direction, wherein the second direction is perpendicular to the first direction;
an internal receiving space within the vehicle body;
an elevator assembly comprising a first support surface being vertically movable and configured to support a storage container;
wherein the vehicle base comprises a base opening, and at least one of the sides comprises a side opening, the side opening allowing passage of a storage container into the internal receiving space and the base opening allowing the elevator assembly to lower a storage container at least partly therethrough.

The first drive means can be a first set of wheels for movement of the container transport vehicle in the first direction. The second drive means can be a second set of wheels for movement of the container transport vehicle in the second direction. Alternatively, the first drive means can be a first belt for movement of the container transport vehicle in the first direction and the second drive means can be a second belt for movement of the container transport vehicle in the second direction.

The storage container can be delivered through the side opening by a container handling vehicle. The container handling vehicle can be a so-called cantilever container handling vehicle.

A dedicated transport vehicle, i.e. the container transport vehicle, could increase the performance in the driving part of the delivery, or it could reduce the total system cost by providing simpler and more dedicated/specialized modules. In order to lower the centre of gravity for the container transport vehicle, the wheel motor/motors, elevator motor/motors, power, and control components may preferably be arranged to any of the sides of the internal receiving space.

The elevator assembly may be operable to move to move a storage container between a lower position in which the storage container extends at least partly through the base opening and a lower end of the storage container is below a lowermost level of the first and second drive means, and an upper position in which the lower end of the storage container is above the lowermost level of the first and second drive means. When in the upper position, the container transport vehicle can transport the storage container across the rail system.

The first support surface may be configured to support the storage container from a side of the storage container and/or from below the storage container.

The first support surface may be a platform which extends between opposite sides of the internal receiving space.

The elevator assembly may comprise a second support surface, and the first support surface and the second support surface may be arranged on opposite sides of the internal receiving space.

The support surfaces may be arranged on opposite sides of the side opening.

The elevator assembly may comprise a movement transferring arrangement for simultaneous movement of the first support surface and the second support surface.

The movement transferring arrangement may comprise a shaft extending over the internal receiving space, and the shaft may be arranged to one side of the upper opening. The shaft may be driven by bands on respective sides. The bands may be connected to the first and second support surfaces.

One motor may be arranged on one of the sides or two motors, i.e. one motor on each side, may be used.

As an alternative to bands, co-driven or separately driven rack and pinion arrangements with a single motor or one motor on each side of the internal receiving space may perform the elevating action of the elevator assembly. In any case, it will be advantageous to have a synchronizing mechanism to ensure even lifting of the storage container.

A first and second pin may project upwardly from the first support surface, the first pin and the second pin may be located at opposing ends of the first support surface, and a third pin and fourth pin may project upwardly from the second support surface, the third pin and the fourth pin may be located at opposing ends of the second support surface. Since the available space in the access opening is limited when a storage container occupies the access opening, the vertical pins take advantage of the recesses in the corners of the storage containers normally used by the guide pins of the lifting frame to align the grippers relative the complementary recesses of the storage container to lower the first and second support surfaces to a position below the access opening of the rail system.

The first support surface and the second support surface may comprise recesses. The recesses may be configured to accommodate complementary shaped ribs on the storage containers supported by the support surfaces. The recesses may be configured to accommodate complementary shaped ribs on the storage containers supported by the support surfaces.

The distance between the first support surface and the second support surface may be adjustable. The distance may be adjusted by moving the first and second support surfaces in the horizontal plane away from each other. A linear motor or other known means may be used for the movement.

Alternatively, or additionally, the first support surface and the second support surface can be hinged such that the first support surface and the second support surface can rotate between a horizontal orientation and a vertical or inclined orientation. Adjusting of the distance may be done instead of, or in addition to, providing recesses in the first support surface and the second support surface.

The container transport vehicle may comprise an upper opening in the upper face of the vehicle body.

Picking may be done through the upper opening. The upper opening may have a cross sectional area which is equal to a cross sectional area of an access opening of a storage container carried by the container transport vehicle.

In order to secure pickers access through the upper opening, the shaft of the movement transferring arrangement can be arranged to side of the upper opening.

The container transport vehicle may comprise a picker arm located on the upper face, for picking through the upper opening.

It is further described an automated storage and retrieval system comprising a two-dimensional rail system comprising a first set of parallel rails in a horizontal plane arranged to guide movement of container handling vehicles in a first direction across the top of a frame structure formed by a plurality of upright members, and a second set of parallel rails in the horizontal plane arranged perpendicular to the first set of parallel rails to guide movement of the container handling vehicles in a second direction which is perpendicular to the first direction, wherein the first set of rails and the second set of rails defines a plurality of access openings and the frame structure defines a plurality of storage columns for accommodating vertical stacks of storage containers below the access openings, on which rail system the container handling vehicles may be operated to raise storage containers from, and lower storage containers into the storage columns, and also to transport the storage containers above the storage columns, wherein the automated storage and retrieval system comprises a storage container, a container handling vehicle, and a container transport vehicle as defined above.

The elevator assembly may be configured to lower a supported storage container into any one of the access openings of the rail system.

The container handling vehicles may comprise a cantilever for carrying a storage container underneath.

The internal receiving space may be configured for accommodating the cantilever of the container handling vehicle and a storage container carried by the cantilever.

A cross-sectional area of the side opening may be equal to or larger than the cantilever of the container handling vehicle and a storage container carried by the cantilever, such that the cantilever carrying a storage container can pass therethrough.

A cross-sectional area of the base opening may be larger than a cross sectional area of the storage container.

The storage container ay comprise vertical ribs on outer sides thereof and the first support surface and the second support surface may comprise recesses, and the recesses may be configured to accommodate the ribs on the storage containers. I.e. the recesses and the vertical ribs have complementary shapes.

The base opening may be equal to a cross sectional area of the access opening of the rail system.

The container transport vehicle may comprise an upper opening in the upper face of the vehicle body, and a cross sectional area of the upper opening may be equal to a cross sectional area of an access opening of the storage container. This eases the picking of the inventory items of the storage container carried by the container transport vehicle.

It is further described a method of transferring a storage container using the automated storage and retrieval system as defined above between a container handling vehicle having a cantilever and a container transport vehicle, wherein the container handling vehicle and the container transport vehicle operate on the same rail system, wherein the method comprises the steps of:
lowering the first support surface of the elevator assembly;
moving the cantilever of the container handling vehicle carrying the storage container into the internal receiving space through the side opening;
lowering the storage container onto the first support surface using a lifting device of the container handling vehicle;
raising the lifting device of the container handling vehicle without the storage container;
moving the cantilever of the container handling vehicle out of the internal receiving space;
lifting, using the elevator assembly, the storage container in the internal receiving space while being supported from below or from the sides until a lower end of the storage container is above the rail system;
transporting the storage container to another location on the rail system using the container transport vehicle.

It is further described a method of transferring a storage container using the automated storage and retrieval system as defined above between a container handling vehicle having a cantilever and a container transport vehicle, wherein the container handling vehicle and the container transport vehicle operate on the same rail system, wherein the method comprises the steps of:
lowering the first support surface of the elevator assembly such that a lower end of a storage container carried by the first support surface extends through the base opening of the vehicle base;
moving the cantilever of the container handling vehicle into the internal receiving space through the side opening;
lowering a lifting device of the container handling vehicle into engagement with the storage container carried by the first support surface;
raising the lifting device of the container handling vehicle carrying the storage container;
moving the cantilever of the container handling vehicle and the carried storage container out of the internal receiving space.

It is further described a method of using the automated storage and retrieval system as defined above for picking up a top storage container which extends at least partly above an access opening formed by a first set of parallel rails and a second set of parallel rails perpendicular to the first set of rails of an automated storage and retrieval system, wherein the method comprises the steps of::
positioning the container transport vehicle such that the top storage container of a stack of storage containers is within the internal receiving space;
lifting, using the elevator assembly, the storage container while being supported by the first support surface in the internal receiving space until a lower end of the storage container is above the rail system;
transporting the storage container to another location on the rail system using the container transport vehicle.

An uppermost storage container of a stack of storage container, or a so-called “top bin” within the art of automated storage and retrieval systems with a framework structure of vertical upright members where storage containers are stacked on top of each other in storage columns between the upright members, is a storage container which extends through the access opening and extends at least partly above the first and second set of rails in the rail system. Container handling vehicles having a cantilever are able to put storage containers on top of stacks of storage containers and retrieve storage container on top of stack of storage containers.

In one aspect, the container transport vehicle comprises:
an upper opening in an upper face for accessing inventory items stored in a storage container carried by the container transport vehicle; and
a picker arm;
   and the method may comprise a step of using the picker arm to pick inventory items from the storage container carried by the container handling vehicle.

The automated storage and retrieval system may comprise a plurality of upright members and each storage column is defined by four of the upright members.

The rail system may be arranged on top of the upright members, the rail system comprising a first set of parallel rails and a second set of parallel rails arranged perpendicular to the first set of rails. The first and second set of rails providing a horizontal grid-based rail system defining a plurality of grid cells. The first and second set of rails of the rail system may comprise one or two tracks. Preferably both directions of rail comprise two tracks (double tracks), e.g., either as two parallel channels formed in a rail, or as a channel provided in each of a pair of rail members that have been fastened to the other to form a rail. In such arrangements the access opening (also named grid opening) and a track-width on each side defines the “grid cell”. In arrangements where one direction of rails has only a single track, the grid cell may extend a full rail-width on those sides.

In the present specification the term “storage container” is intended to mean any goods holder unit having a bottom plate and side portions suitable for releasable connection to the container lift device, e.g. a bin, a tote, a tray or similar. The side portions may preferably comprise gripping recesses. The side portions are preferably sidewalls. The height of the sidewalls may vary depending on the intended use of the automated storage and retrieval system and the goods to be stored. The gripping recesses may be arranged at an upper rim of the sidewalls. The outer horizontal periphery of the storage container is preferably rectangular.

The relative terms “upper”, “lower”, “below”, “above”, “higher” etc. shall be understood in their normal sense and as seen in a cartesian coordinate system.

The invention may be used in connection with storage containers and systems as described above. However, other areas where the disclosed automated storage and retrieval system and methods may be used is within vertical farming, micro-fulfilment or grocery/e-grocery.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a frame structure of a prior art automated storage and retrieval system;

FIG. 2 is a perspective view of a prior art container handling vehicle having an internally arranged cavity for carrying storage containers therein;

FIG. 3 is a perspective view of a prior art container handling vehicle having a cantilever for carrying storage containers underneath;

FIG. 4 is a perspective view, seen from below, of a prior art container handling vehicle having an internally arranged cavity for carrying storage containers therein;

FIG. 5 is a perspective view of the container handling vehicle in FIG. 4 without side and top panels;

FIGS. 6A-6C show of a first embodiment of a container transport vehicle adapted to receive a storage container from a cantilever-type container handling vehicle, wherein the container transport vehicle comprises a closed upper face and an elevator assembly supporting a storage container from the sides, where FIG. 6A is a perspective view from a first direction, FIG. 6B is a perspective view from a second direction, and FIG. 6C is side view of FIGS. 6A and 6B;

FIGS. 7A-7D shows a sequence of a cantilever-type container handling vehicle picking up a storage container supported by first and second support surfaces of an elevator assembly in a second embodiment of container transport vehicle, the container transport vehicle comprises an upper opening in the upper face and an elevator assembly supporting a storage container from the sides, and where: in FIG. 7A the storage container is lifted by the elevator assembly to an upper position, in FIG. 7B the storage container is lowered by the elevator assembly to a lower position such that a lower end of the storage container is lowered through a base opening of the vehicle base to make available space above the storage container for a cantilever of the cantilever-type container handling vehicle, in FIG. 7C the cantilever-type container handling vehicle enters through a side opening of the container transport vehicle and into a receiving space of the container transport vehicle, and in FIG. 7D the cantilever-type container handling vehicle has lifted the storage container from the support surfaces of the elevator assembly and can drive out of the internal receiving space through the side opening of the container transport vehicle;

FIGS. 8A and 8B are different views of the second embodiment of container transport vehicle of FIGS. 7A-7D not carrying a storage container, where FIG. 8A is a perspective view and FIG. 8B is a side view;

FIG. 9A shows examples of storage containers with the same cross section but different heights;

FIG. 9B is a top view of a support surface with recesses for making space of complementary shaped ribs on the storage containers;

FIG. 10A shows of a third embodiment of a container transport vehicle which can receive a storage container from a cantilever-type container handling vehicle, wherein the container transport vehicle comprises an upper opening in an upper face and an elevator assembly supporting a storage container from below;

FIG. 10B shows details of a support surface to be used in the container transport vehicle in FIG. 10A supporting a storage container from below;

FIG. 11 shows a fourth embodiment of a container transport vehicle adapted to receive a storage container from a cantilever-type container handling vehicle, wherein the container transport vehicle comprises an upper opening in the upper face, an elevator assembly supporting a storage container from the sides and a picker arm arranged on the upper face;

FIG. 12 shows a fifth embodiment of a container transport vehicle adapted to receive a storage container from a cantilever-type container handling vehicle, wherein the container transport vehicle comprises an upper opening in the upper face, an elevator assembly supporting a storage container from below, wherein the support surface is a platform extending over the internal receiving space;

FIGS. 13A and 13B show details of an elevator assembly 10 to be used with all of the first, second, third, fourth and fifth embodiments of the container transport vehicle 501′;501″;501′″;501″″;501′″″ where the body of the container transport vehicle has been omitted in order to better illustrate the components of the elevator assembly 10, where in the FIG. 13A a storage container is supported by the first support surface 11 (and the second support surface 11), and in FIG. 13B the storage container 106 in FIG. 13A has been removed.

FIG. 14A is a side perspective view of a storage container with vertical ribs on an outer surface thereof and indication of an access opening of the storage container;

FIG. 14B is a top view of the storage container of FIG. 14A with an outlined access opening;

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

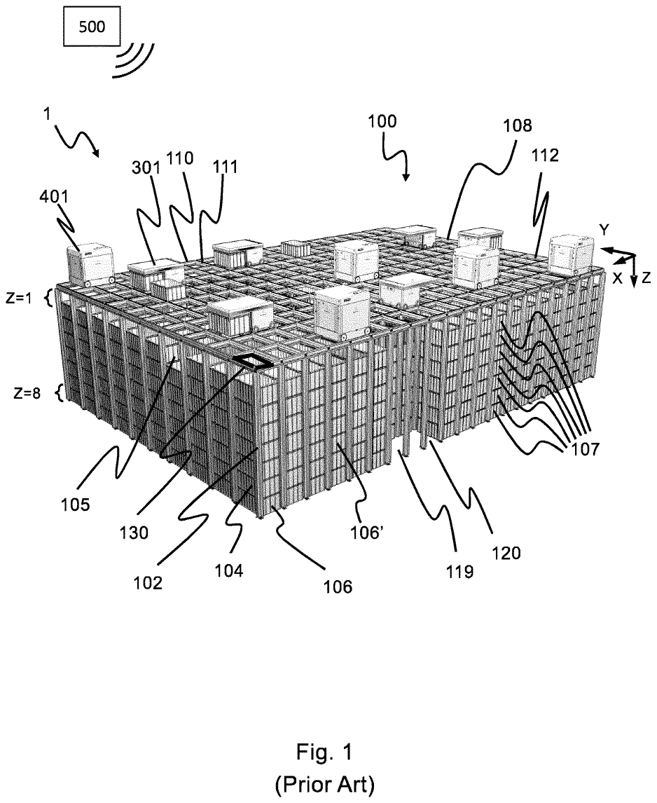

A frame structure 100 of the automated storage and retrieval system 1 may be constructed in a similar manner to the prior art frame structure 100 described above in connection with FIG. 1. That is, the frame structure 100 may comprise a number of upright members 102, and comprise a rail system 108 extending in the first direction (X direction) and the second direction (Y direction). I.e. the rail system 108 may be arranged on top of the upright members 102, the rail system 108 comprising a first set of parallel rails 110 and a second set of parallel rails 111 arranged perpendicular to the first set of rails 110. The first and second set of rails 110,111 providing a horizontal grid-based rail system 108 defining a plurality of grid cells 130. The first and second set of rails 110,111 of the rail system 108 may comprise one or two tracks. Preferably both directions of rail comprise two tracks (double tracks), e.g., either as two parallel channels formed in a rail, or as a channel provided in each of a pair of rail members that have been fastened to the other to form a rail. In such arrangements the access opening (also named grid opening) and a track-width on each side defines the “grid cell” 130. In arrangements where one direction of rails has only a single track, the grid cell 130 may extend a full rail-width on those sides.

The frame structure 100 may comprise storage compartments in the form of storage columns 105 provided between the members 102 wherein storage containers 106 may be stackable in stacks 107 within the storage columns 105.

The frame structure 100 can be of any size. In particular, it is understood that the frame structure can be considerably wider and/or longer and/or deeper than disclosed in FIG. 1. For example, the frame structure 100 may have a horizontal extent of more than 700×700 columns and a storage depth of more than twelve containers.

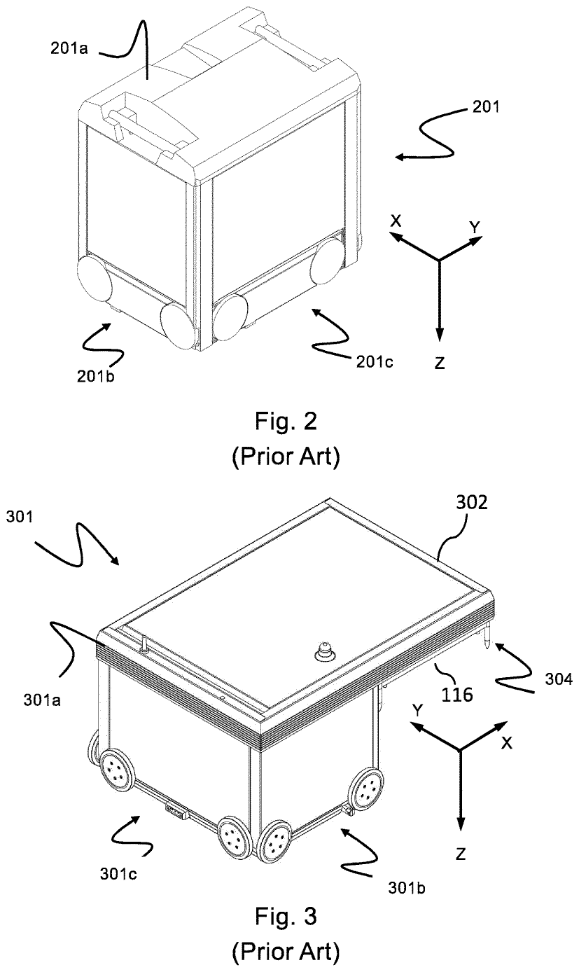

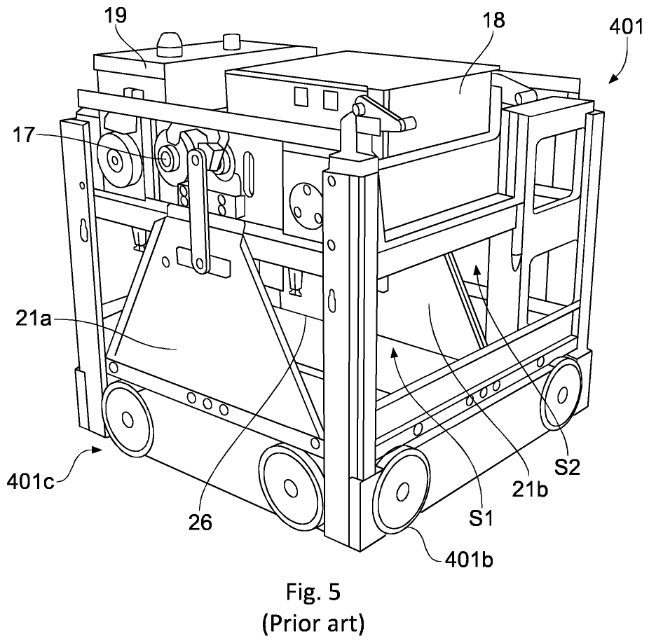

The prior art container handling vehicles comprising a cavity for accommodating a storage container (cavity-type container handling vehicles), see FIGS. 2, 4 and 5, have certain advantageous features. In particular, the guidance/support provided to a storage container when accommodated in the cavity entails that the cavity-type container handling vehicles may have increased acceleration/deceleration relative to the cantilever-type container handling vehicle 301 shown in FIG. 3. However, the potential increase in acceleration/deceleration is not fully realized due to instability of the cavity-type container handling vehicles. The instability is caused by the cavity-type container handling vehicles 201,401 having most of the drive, power, control and lifting components arranged above the cavity, providing a high centre of gravity.

According to all of the different embodiments of the container transport vehicle according to the invention, and in contrast to the prior art cavity-type container handling vehicles 201,401, most of the drive, power, control and lifting components are arranged to any of the sides of the container receiving space, thereby lowering the centre of gravity compared to the prior art cavity-type container handling vehicles 201,401.

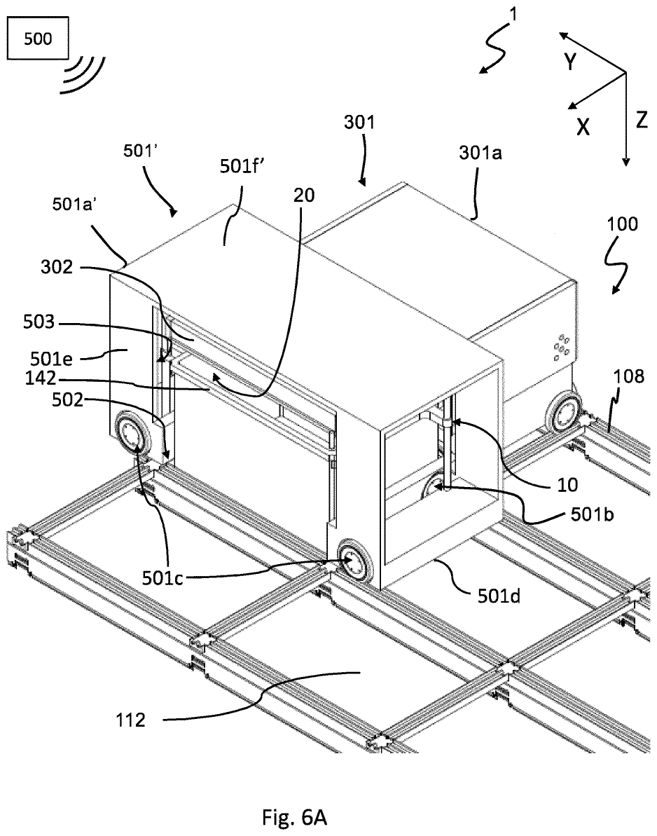

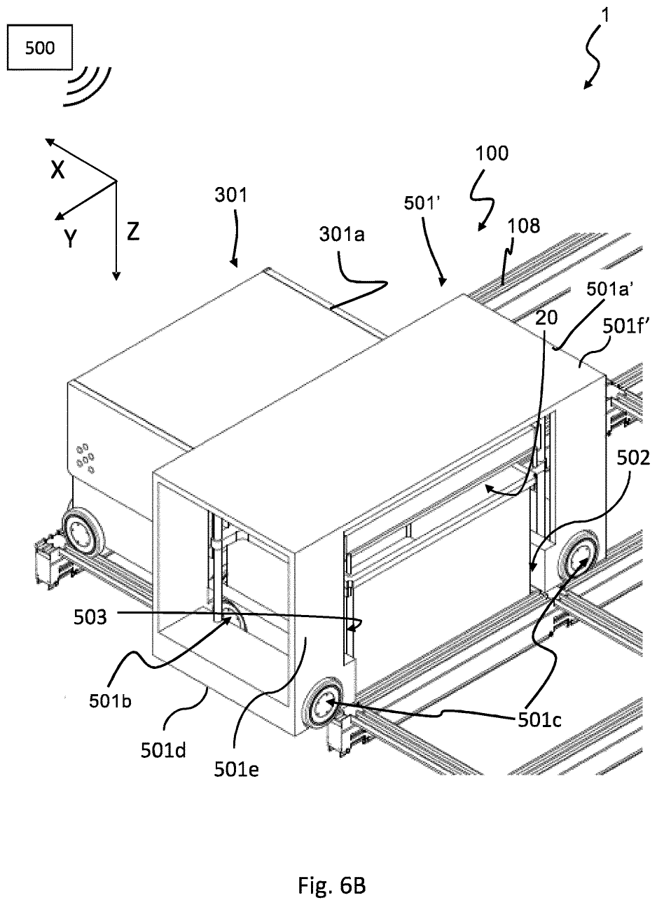

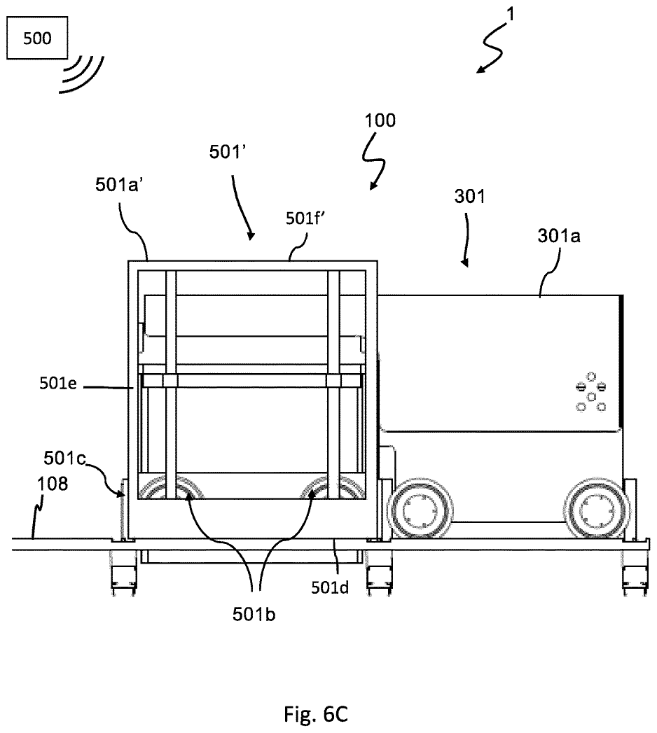

FIGS. 6A-6C show of a first embodiment of a container transport vehicle 501′ receiving a storage container 106 from a cantilever-type container handling vehicle 301, where FIG. 6A is a perspective view from a first direction, FIG. 6B is a perspective view from a second direction, and FIG. 6C is side view of FIGS. 6A and 6B. I.e., all of FIGS. 6A-6C which show the same time-lapse from different perspective views.

The container transport vehicle 501′ and the cantilever-type container handling vehicle 301 operate on a rail system 108 of an automated storage and retrieval system 1.

The container transport vehicle 501′ in FIGS. 6A-6C comprises a vehicle body 501a′ defining a vehicle base 501d, four sides 501e, and an upper face 501f′ opposite the vehicle base 501d. The upper face 501f′ is closed.

The container transport vehicle 501′ further features a first drive means in the form of a first set of wheels 501b′ for movement of the container transport vehicle 501′ in a first direction X on the rail system 108 and a second drive means in the form of a second set of wheels 501c′ for movement of the container transport vehicle 501′ in a second direction Y on the rail system 108, wherein the second direction Y is perpendicular to the first direction X. An internal receiving space 20 is arranged within the vehicle body 501a′.

The container transport vehicle 501′ further comprises an elevator assembly 10 comprising a first support surface 11 and a second support surface 12 which are vertically movable and configured to support a storage container 106.

The first support 11 and the second support 12 are arranged in an upper part of the container transport vehicle 501″ and is configured to engage with a collar 142 or similar of the storage container 106 in order to lift and lower the storage container 106 when supported by the first support surface 11 and the second support surface 12.

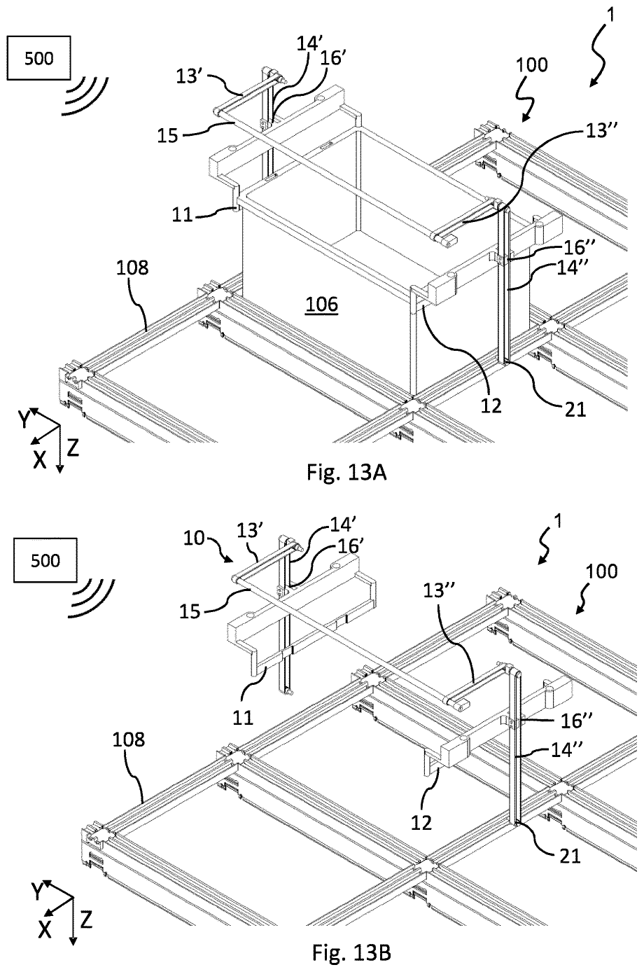

More details of the elevator assembly 10 are shown in FIGS. 13A and 13B and accompanying description. The vehicle base 501d comprises a base opening 502 allowing the elevator assembly 10 to lower a storage container 106 from the internal receiving space 20 and at least partly therethrough. At least one of the sides 501e comprises a side opening 503. The side opening 503 allows passage of a storage container 106 into the internal receiving space 20.

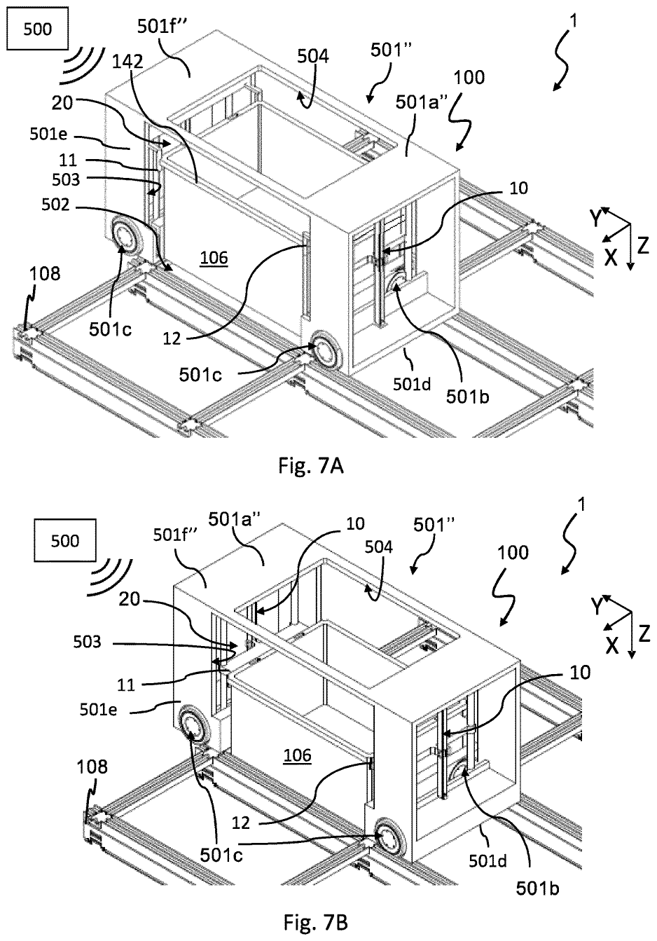

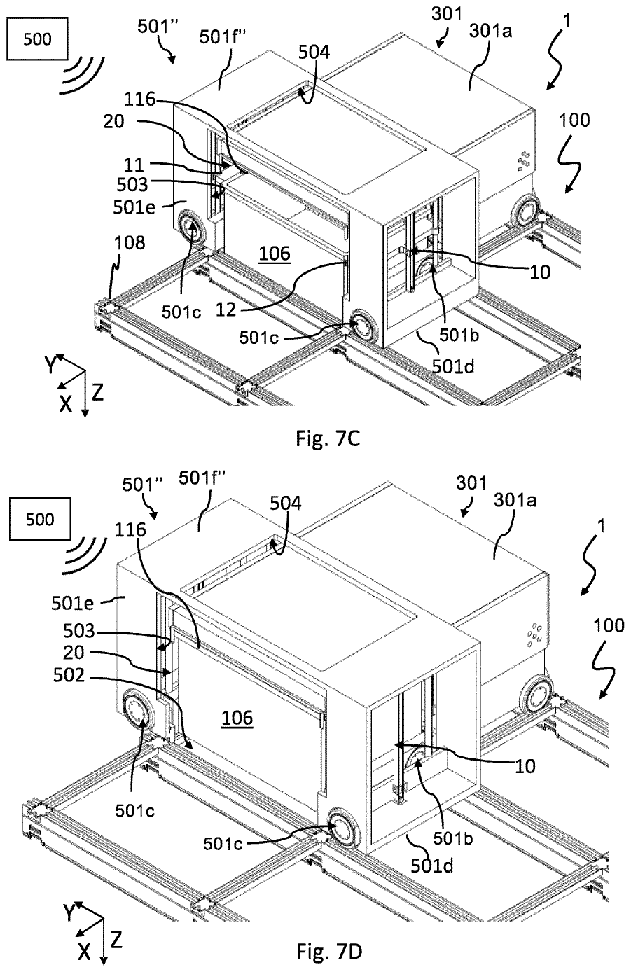

FIGS. 7A-7D shows a sequence of a cantilever-type container handling vehicle 301 picking up a storage container 106 supported by first and second support surfaces 11, 12 of an elevator assembly 10 in a second embodiment of the container transport vehicle 501″. The container transport vehicle 501″ in FIGS. 7A-7D comprises an upper opening 504 in the upper face 501f″ and an elevator assembly 10 supporting a storage container 106 from the sides. In FIG. 7A the storage container 106 is lifted by the elevator assembly 10 to an upper position, in FIG. 7B the storage container 106 is lowered by the elevator assembly to a lower position where a lower end of the storage container 106 is lowered through a base opening 502 of the vehicle base 501d to make available space above the storage container 106 for a cantilever 302 of a cantilever-type container handling vehicle 301, in FIG. 7C the cantilever-type container handling vehicle 301 enters through a side opening 503 of the container transport vehicle 501″ and into a receiving space 20 of the container transport vehicle 501″, and in FIG. 7D the cantilever-type container handling vehicle 301 has lifted the storage container 106 from the first and second support surfaces 11, 12 of the elevator assembly 10 and can drive out of the internal receiving space 20 through the side opening 503 of the container transport vehicle 501″.

The second embodiment of the container transport vehicle 501″ in FIGS. 7A-7D features:
a vehicle body 501a″ defining a vehicle base 501d, four sides 501e, and an upper face 501f″ opposite the vehicle base 501d;
first drive means in the form of a first set of wheels 501b for movement of the container transport vehicle 501″ in a first direction X;
second drive means in the form of a second set of wheels 501, for movement of the container transport vehicle 501″ in a second direction Y, wherein the second direction Y is perpendicular to the first direction X.

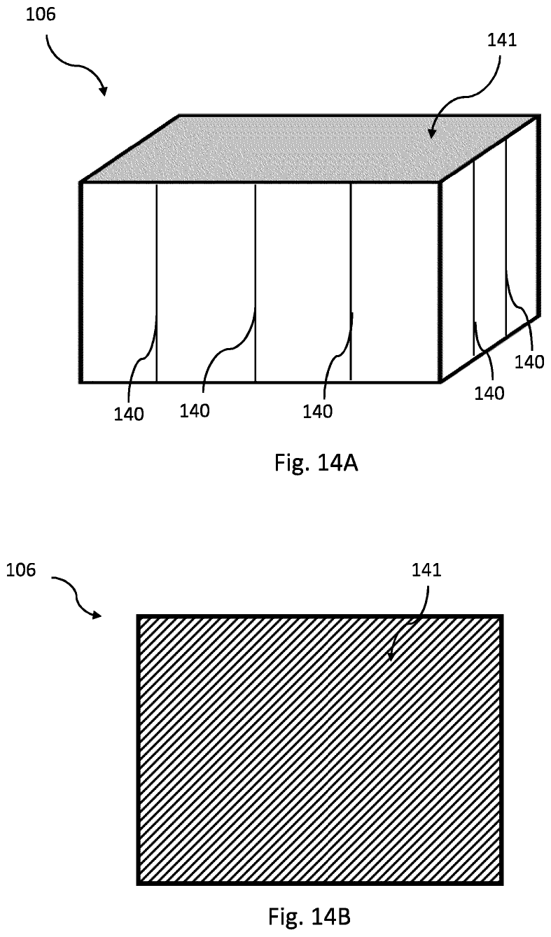

The container transport vehicle 501″ comprises an upper opening 504 in the upper face 501f″ of the vehicle body 501a″. A cross sectional area of the upper opening 504 is preferably equal to a cross sectional area of an access opening 141 of the storage container 106 (see e.g. FIGS. 14A and 14B).

The first support 11 and the second support 12 are arranged in an upper part of the container transport vehicle 501″ and is configured to engage with a collar 142 or similar of the storage container 106 in order to lift and lower the storage container 106 when supported by the first support surface 11 and the second support surface 12.

Referring to FIGS. 7A-7D sequential steps of receiving a storage container 106 from a cantilever-type container handling vehicle 301 onto a first support surface 11 and a second support surface 12 of a container transport vehicle 501′ operating on the same rail system 108 will be explained in greater detail.

In FIG. 7A the storage container 106 is lifted by the elevator assembly 10 to an upper position.

In FIG. 7B the first support surface 11 of the elevator assembly 10 has been lowered such that a lower part of the storage container 106 extends through the base opening 502 of the vehicle base 501d. In addition, is has been made space for a cantilever 302 of a container handling vehicle 301 inside the internal receiving space 20 above the storage container 106. The first support surface 11 still carrying or supporting the storage container 106.

In FIG. 7C, the cantilever 302 of the container handling vehicle 301 has been moved through the side opening 503 of the container transport vehicle 501″ such that the cantilever 302 is positioned inside the internal receiving space 20 of the container transport vehicle 501″.

In FIG. 7D the lifting device 116 of the container handling vehicle 301 has been lowered into engagement with the storage container 106 and the lifting device 116 of the container handling vehicle 301 carries the storage container 106.

The cantilever 302 of the container handling vehicle 301 and the carried storage container 106 can now be moved out of the internal receiving space 20 through the side opening 503.

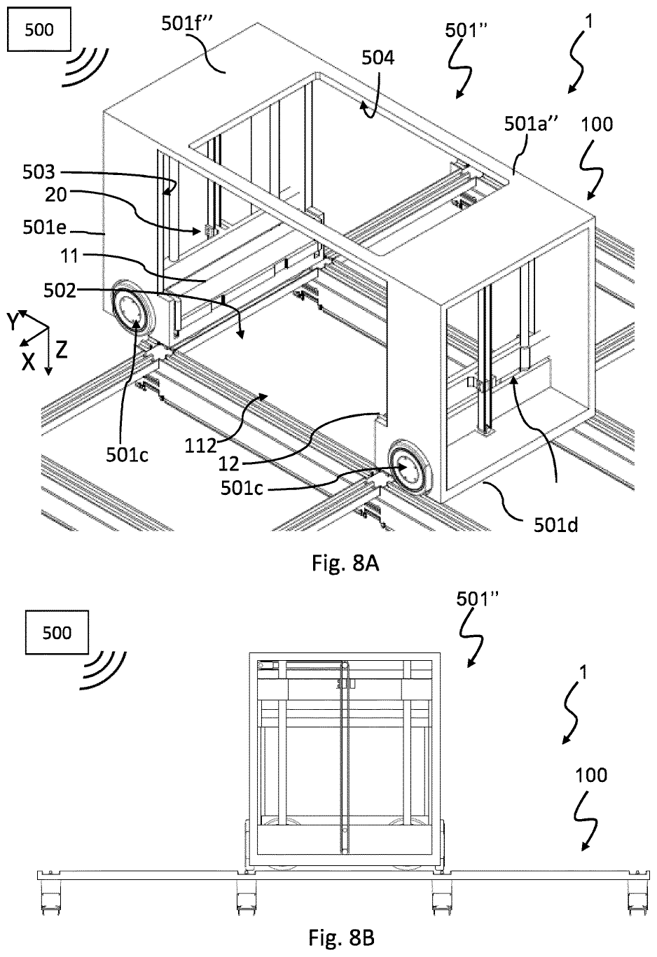

FIGS. 8A and 8B are different views of the second embodiment of container transport vehicle 501″ of FIGS. 7A-7D not carrying a storage container, where FIG. 8A is a perspective view and FIG. 8B is a side view. All of the elements of the container transport vehicle 501″ are similar to the container transport vehicle in FIGS. 7A-7D except that the elevator assembly 10 is able to lower a storage container 106 further down through the base opening 502 (and the underlying access opening 112) compared to the container transport vehicle 501″ in FIGS. 7A-7D. This is achieved by lowering the first support 11 and the second support 12 further downwards.

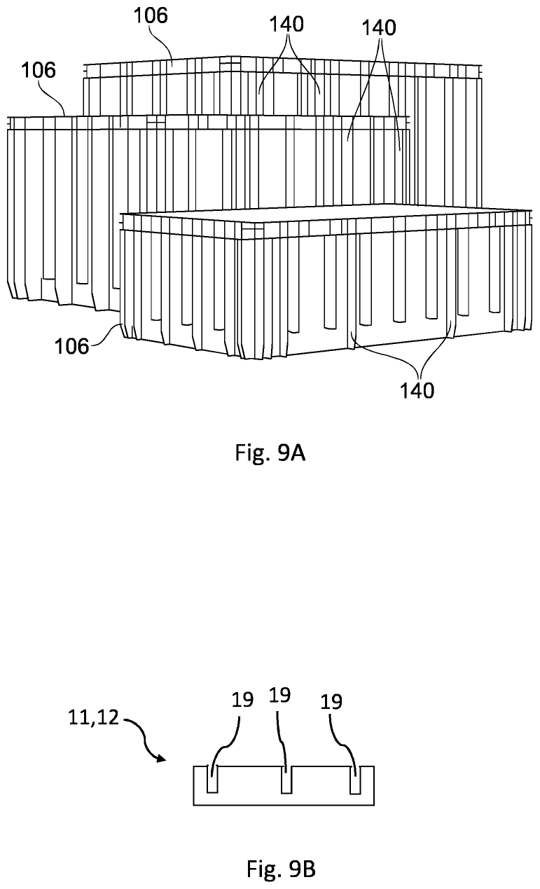

FIG. 9A shows examples of storage containers 106 with the same cross section but different heights. The storage containers have vertical ribs 140 for increasing rigidity of the storage containers 106.

FIG. 9B is a top view of first and second support surfaces 11,12 with recesses 19 for making space of complementary shaped ribs 140 on the storage containers 106.

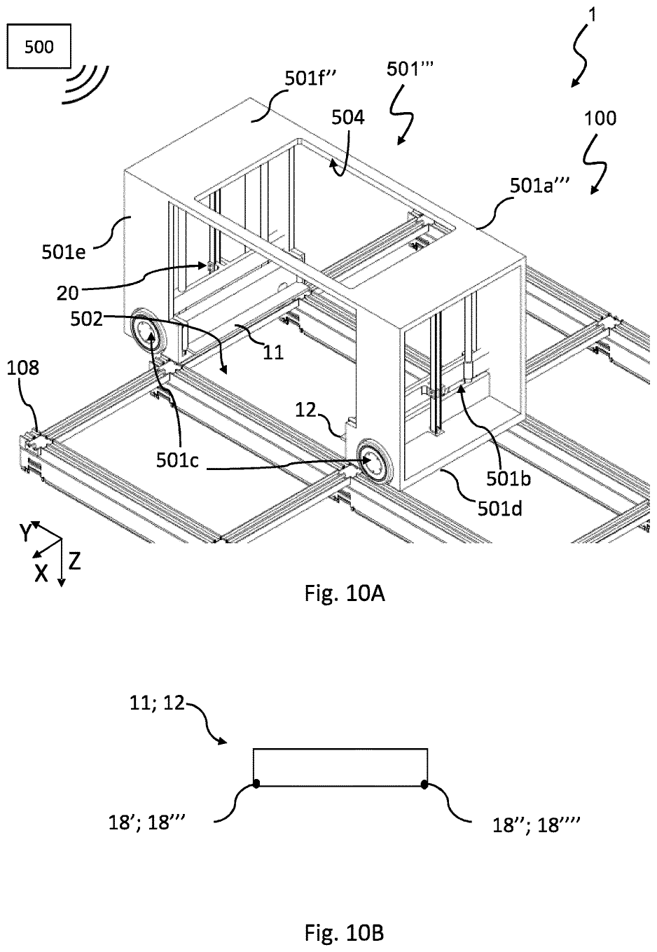

FIG. 10A shows of a third embodiment of a container transport vehicle 501′″ which can receive a storage container 106 from a cantilever-type container handling vehicle 301. The container transport vehicle 501′″ comprises an upper opening 504 in an upper face 501f″ and an elevator assembly 10 supporting a storage container from below. As is seen from the Figure, the first support 11 and the second support 12 are arranged in a lower part of the container transport vehicle 501′″ such that a storage container 10 can be placed onto the first and second supports 11,12 and thus the container transport vehicle 501′″ supports the storage container 106 from below.

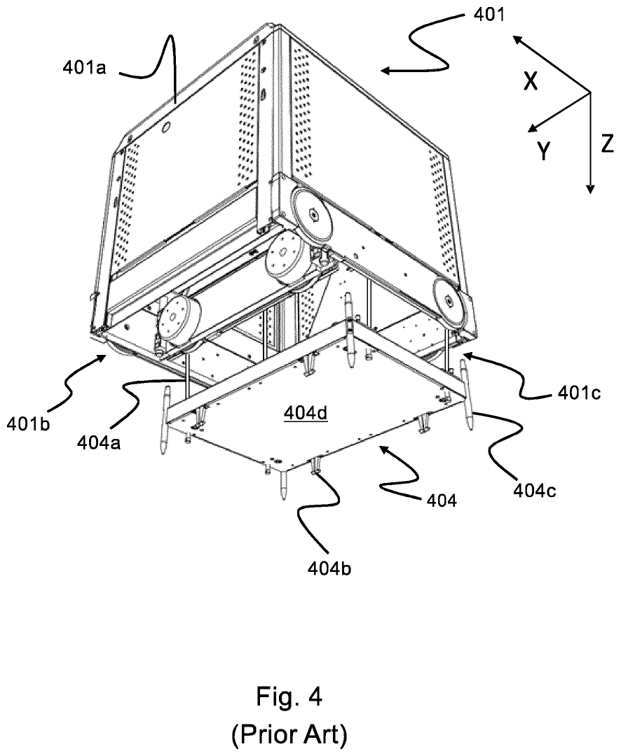

FIG. 10B shows details of a support surface 11,12 to be used in the container transport 501′″ vehicle in FIG. 10A supporting a storage container from below. A first pin 18′ and a second pin 18″ project upwardly from the first support surface 11. The first pin 18′ and the second pin 18″ are located at opposing ends of the first support surface 11. Similarly, a third pin 18′″ and fourth pin 18′″ project upwardly from the second support surface 12, the third pin 18′″ and the fourth pin 18″″ are located at opposing ends of the second support surface 12. The size and shape of the first pin 18′, the second pin 18″, the third pin 18′″ and the fourth pin 18″″ are preferably of same size and shape as the guide pins 404c (not shown in FIGS. 10A and 10B, see e.g. FIG. 4) on the lifting frame 404d (see FIG. 4) because the available space between the storage container 106 and the access opening 112 is limited.

The elevator assembly 10 can be lowered such that the first and second support surfaces 11,12 can extend through the base opening 502 of the vehicle base 501d.

The remaining components of the container transport vehicle 501′″ according to the third embodiment in FIGS. 10A and 10B are similar to the container transport vehicle 501″ of the second embodiment described in relation to FIGS. 7A-7D and will not be repeated herein.

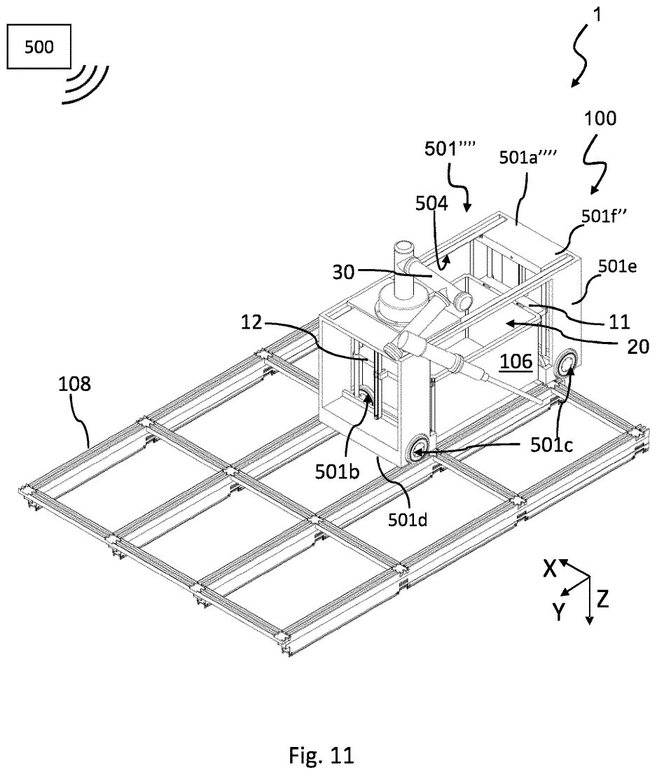

FIG. 11 shows a fourth embodiment of a container transport vehicle 501″″ adapted to receive a storage container 106 from a cantilever-type container handling vehicle 301, wherein the container transport vehicle 501″″ comprises an upper opening 504 in the upper face 501f″, an elevator assembly 10 supporting a storage container from the sides and a picker arm 30 arranged on the upper face 501f″. The picker arm 30 is able to reach inventory items stored in the storage container 106 carried by the container transport vehicle 501″″ through the upper opening 504.

The remaining components of the container transport vehicle 501″″ according to the fourth embodiment in FIG. 11 are similar to the container transport vehicle 501″ of the second embodiment described in relation to FIGS. 7A-7D and will not be repeated herein.

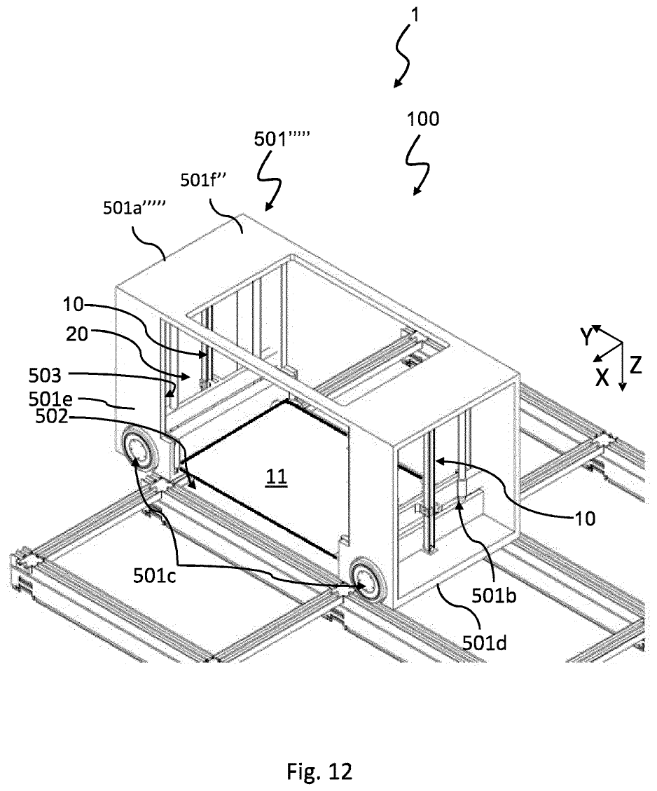

FIG. 12 shows a fifth embodiment of a container transport vehicle 501′″″ adapted to receive a storage container 106 from a cantilever-type container handling vehicle 301, wherein the container transport vehicle 501″″ comprises an upper opening 504 in the upper face 501f″, an elevator assembly 10 supporting a storage container 106 from below, wherein the support surface 11 is a platform 11 extending over the internal receiving space 20, i.e. the support platform 11 extends from one side of the internal receiving space 20 to an opposite end of the internal receiving space 20.

The elevator assembly 10 can be lowered such that the first support surface 11 (i.e. the platform 11) can extend through the base opening 502 of the vehicle base 501d.

Similar to the container transport vehicle 501′″ according to the third embodiment shown in FIG. 10A and the support surface 11 in FIG. 10B, the platform 11 can have pins (not shown, see e.g. FIG. 10B) in each of the corners thereof projecting upwardly from the support surface 11. The pins are preferably of same size and shape as the guide pins 404c (not shown in FIGS. 10A and 10B, see e.g. FIG. 4) on the lifting frame 404d (see FIG. 4) because the available space between the storage container 106 and the access opening 112 is limited. The platform 11 can have a cross-sectional area which is substantially of the same size as the cross-sectional area of the storage container 106.

The remaining components of the container transport vehicle 501″″ according to the fourth embodiment in FIG. 11 are similar to the container transport vehicle 501″ of the second embodiment described in relation to FIGS. 7A-7D and will not be repeated herein.

FIGS. 13A and 13B show details of an elevator assembly 10 to be used with all of the first, second, third, fourth and fifth embodiments of the container transport vehicle 501′;501″;501′″;501″″;501′″″ where the body of the container transport vehicle has been omitted in order to better illustrate the components of the elevator assembly 10, where in the FIG. 13A a storage container is supported by the first support surface 11 (and the second support surface 11), and in FIG. 13B the storage container 106 in FIG. 13A has been removed.

The elevator assembly 10 comprises a movement transferring arrangement 13′,13″, 14′,14″, 15 for simultaneous movement of the first support surface 11 and the second support surface 12. The movement transferring arrangement is disclosed with a shaft 15 extending above the internal receiving space 20. The shaft 15 extends from one end of the internal receiving space 20 to an opposite second end of the internal receiving space 20.

The elevator assembly 10 comprises a motor 21 driving a first vertical extending band 14′ arranged on one side of the internal receiving space 20 and a second vertical extending band 14″ on an opposite side of the internal receiving space 20. The first vertical extending band 14′are connected to the second vertical extending band 14″ via a shaft 15 and first and second lateral extending bands 13′,13″. The first support surface 11 is connected the first vertical extending band 14′ in a first connection point 16′ and the second support surface 12 is connected the second vertical extending band 14″ in a second connection point 16″ for lowering and lifting of the first and second support surfaces 11,12. The shaft 15 ensures simultaneous movement of the first support surface 11 and the second support surface 12. As shown in FIGS. 13A and 13B, the shaft 15 is arranged to the side of the internal receiving space 20 in order to provide access to inventory items stored in a storage container 106 carried by the container transport vehicle.

FIG. 14A is a side perspective view of a storage container 106 with vertical ribs 140 on an outer surface thereof and indication of an access opening 141 of the storage container 106.

FIG. 14B is a top view of the storage container of FIG. 14A with an outlined access opening 141 of the storage container 106.

Common to all of the embodiments of the container transport vehicle 501′;501″;501′″;501″″;501′″″, they may be used on an automated storage and retrieval system 1 comprising a two-dimensional rail system 108 comprising a first set of parallel rails 110 in a horizontal plane arranged to guide movement of container handling vehicles 201,301,401,501 in a first direction X across the top of a frame structure 100 formed by a plurality of upright members 102, and a second set of parallel rails 111 in the horizontal plane arranged perpendicular to the first set of parallel rails 110 to guide movement of the container handling vehicles 201,301,401,501) in a second direction Y which is perpendicular to the first direction X, wherein the first set of rails and the second set of rails defines a plurality of access openings 112 (see e.g. FIG. 6A) and the frame structure 100 defines a plurality of storage columns 105 for accommodating vertical stacks of storage containers 106 below the access openings 112. The automated storage and retrieval system 1 may, in addition to all of the the embodiments of the container transport vehicle 501′;501″;501′41 ;501″″;501′″″ comprise a storage container 106 and a container handling vehicle 301. The elevator assembly 10 of the container transport vehicle 501′;501″;501′″;501″″;501′″″ is configured to lower a supported storage container 106 into any one of the access openings 112 of the rail system 108.

Since the uppermost storage container 106 of a stack 107 of storage container does not extend all the way up to above the first and second set of rails 110,11 of the rail system 108, there is some space for the elevator assembly to lower a storage container 106 at least partly through the access opening 112 of the rail system sufficient for a cantilever 302 of a container handling vehicle 301 to enter into the receiving space 20 above the storage container 106 caried by the elevator assembly 10.

In addition, all of the embodiments of the container transport vehicles are able to retrieve and put a top storage container 106, or a so-called “top bin” within the art of automated storage and retrieval systems 1. A top storage container 106 is a storage container which extends through the access opening 112 and extends at least partly above the first and second set of rails 110,111 in the rail system 108. The container handling vehicles 301 having a cantilever 302 are also able to put storage containers on top of stacks 107 of storage containers 106 and retrieve storage container 106 on top of stacks 107 of storage containers 106.

Common to all of the embodiments of different container transport vehicles 501′;501″;501′″;501″″;501′″″, when a storage container 106 shall be transferred from the container transport vehicle 501′;501″;501′″;501″″;501′″″ to a container handling vehicle 301 operating on the same rail system 108, the sequence can be as follows:
lowering the first support surface 11 of the elevator assembly 10 such that a lower end of a storage container 106 carried by the first support surface 11 extends through the base opening 502 of the vehicle base 501d;
moving the cantilever 302 of the container handling vehicle 301 into the internal receiving space 20 through the side opening 503;
lowering a lifting device 116 of the container handling vehicle 301 into engagement with the storage container 106;
raising the lifting device 116 of the container handling vehicle 301 carrying the storage container 106;
moving the cantilever 302 of the container handling vehicle 301 and the carried storage container 106 out of the internal receiving space 20.

Common to all of the embodiments of different container transport vehicles 501′;501″;501′″;501″″;501′″″, when a storage container 106 shall be transferred from the container handling vehicle 301 to the container transport vehicle 501′;501″;501′″;501″″;501′″″ operating on the same rail system 108, the sequence can be as follows:
lowering the first support surface 11 of the elevator assembly 10;
moving the cantilever 302 of the container handling vehicle 301 carrying the storage container 106 into the internal receiving space 20 through the side opening 503;
lowering the storage container 106 onto the first support surface 11 using a lifting device 116 of the container handling vehicle 301;
raising the lifting device 116 of the container handling vehicle 301 without the storage container 106;
moving the cantilever 302 of the container handling vehicle 301 out of the internal receiving space 20;
lifting, using the elevator assembly 10, the storage container 106 in the internal receiving space 20 while being supported from below or from the sides until a lower end of the storage container 106 is above the rail system 108;
transporting the storage container 106 to another location on the rail system 108 using the container transport vehicle 501′;501″;501′″;501″″;501′″″.

In the preceding description, various features of the embodiments have been described. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention as defined in the attached claims.

### LIST OF REFERENCE NUMBERS

1 Prior art automated storage and retrieval system
10 Elevator assembly
11 First support surface
12 Second support surface
13′ First lateral extending band
13″ Second lateral extending band
14′ First vertical extending band
14″ Second vertical extending band
15 Shaft
16′ First connection point
16″ Second connection point
18′ First pin
18″ Second pin
18′″ Third pin
18″″ Fourth pin
19 Recess
20 Internal receiving space
21 Motor elevator assembly
30 Picker arm
100 Frame structure
102 Upright member
104 Storage volume
105 Storage column
106 Storage container
106′ Particular position of storage container
107 Stack
108 Rail system
110 First set of parallel rails (in first direction (X))
111 Second set of parallel rails (in second direction (Y))
112 Access opening
116 Lifting device
119 Delivery column
120 Delivery column
130 Grid cell
140 Vertical rib
141 Access opening of storage container
142 Collar of storage container
201 Prior art container handling vehicle
201a Vehicle body of the container handling vehicle 201
201b Drive means/wheel arrangement/first set of wheels in first direction (X)
201c Drive means/wheel arrangement/second set of wheels in second direction (Y)
301 Prior art cantilever container handling vehicle
301a Vehicle body of the container handling vehicle 301
301b Drive means/first set of wheels in first direction (X)
301c Drive means/second set of wheels in second direction (Y)
302 Cantilever
401 Prior art container handling vehicle
401a Vehicle body of the container handling vehicle 401
401b Drive means/first set of wheels in first direction (X)
401c Drive means/second set of wheels in second direction (Y)
404 Gripping device
404a Lifting band
404b Gripper
404c Guide pin
404d Lifting frame
500 Control system
501′ Container transport vehicle, first embodiment
501a″ Vehicle body of the container transport vehicle 501′
501b First drive means/wheel arrangement/first set of wheels in first direction (X)
501c Second drive means/wheel arrangement/second set of wheels in second direction (Y)
501d Vehicle base
501e Side
501f′ Upper face
501″ Container transport vehicle, second embodiment
501a″ Vehicle body of the container transport vehicle 501″
501f″ Upper face
501′″ Container transport vehicle, third embodiment
501a′″ Vehicle body of the container transport vehicle 501′″
501″″ Container transport vehicle, fourth embodiment
501a″″ Vehicle body of the container transport vehicle 501″″
501f″″ Upper face
501′″″ Container transport vehicle, fifth embodiment
501a′″″ Vehicle body of the container transport vehicle 501′″″
501f′″″ Upper face
502 Base opening
503 Side opening
504 Upper opening
X First direction
Y Second direction
Z Third direction

1.-24. (canceled)

25. A container transport vehicle for operation on a rail system of an automated storage and retrieval system, the container transport vehicle comprising:
a vehicle body defining: a vehicle base, four sides, and an upper face opposite the vehicle base;
a first drive means for movement of the container transport vehicle in a first direction;
a second drive means for movement of the container transport vehicle in a second direction;
an internal receiving space within the vehicle body; and
an elevator assembly comprising a first support surface being vertically movable and configured to support a storage container,
wherein the vehicle base comprises a base opening, and at least one of the sides comprises a side opening,
wherein the side opening is configured to allow passage of a storage container into the internal receiving space, and
wherein the base opening is configured to allow the elevator assembly to lower a storage container at least partly therethrough.

26. The container transport vehicle according to claim 25, wherein the elevator assembly is configured to move the storage container between a lower position in which the storage container extends at least partly through the base opening and a lower end of the storage container is below a lowermost level of the first and second drive means, and an upper position in which the lower end of the storage container is above the lowermost level of the first and second drive means.

27. The container transport vehicle according to claim 25, wherein the first support surface is configured to support the storage container from a side of the storage container and/or from below the storage container.

28. The container transport vehicle according to claim 25, wherein the first support surface is a platform which extends between opposite sides of the internal receiving space.

29. The container transport vehicle according to claim 25, wherein the elevator assembly comprises a second support surface, and wherein the first support surface and the second support surface are arranged on opposite sides of the internal receiving space.

30. The container transport vehicle according to claim 29, wherein the elevator assembly comprises a movement transferring arrangement for simultaneous movement of the first support surface and the second support surface.

31. The container transport vehicle according to claim 29, wherein the first support surface and the second support surface comprise recesses, wherein the recesses are configured to accommodate the storage container.

32. The container transport vehicle according to claim 25, comprising an upper opening in the upper face of the vehicle body.

33. The container transport vehicle according to claim 32, comprising a picker arm located on the upper face for picking through the upper opening.

34. An automated storage and retrieval system comprising:
a rail system defining a plurality of access openings;
one or more container handling vehicles configured to raise storage containers from, and lower storage containers into the automated storage and retrieval system;
one or more storage containers; and
a container transport vehicle according to claim 25.

35. The automated storage and retrieval system according to claim 34, wherein the elevator assembly is configured to lower a storage container into any one of the access openings of the rail system.

36. The automated storage and retrieval system according to claim 34, wherein the one or more container handling vehicles comprise a cantilever for carrying storage containers.

37. The automated storage and retrieval system according to claim 36, wherein the internal receiving space is configured to accommodate the cantilever of the container handling vehicle and a storage container carried by the cantilever.

38. The automated storage and retrieval system according to claim 37, wherein a cross-sectional area of the side opening is equal to or larger than the cantilever of the container handling vehicle and a storage container carried by the cantilever, such that the cantilever carrying a storage container can pass therethrough.

39. The automated storage and retrieval system according to claim 34, wherein a cross-sectional area of the base opening is larger than a cross-sectional area of a storage container.

40. The automated storage and retrieval system according to claim 34, wherein each of the one or more storage containers comprises vertical ribs on outer sides thereof and wherein the first support surface and the second support surface comprise recesses configured to accommodate the ribs of the one or more storage containers.

41. The automated storage and retrieval system according to claim 34, wherein the container transport vehicle comprises an upper opening in the upper face of the vehicle body, and wherein a cross-sectional area of the upper opening is equal to a cross-sectional area of an opening of the storage container.

42. A method of transferring a storage container between a container handling vehicle having a cantilever and a container transport vehicle using an automated storage and retrieval system as recited in claim 34.

43. The method of transferring a storage container according to claim 42 comprising:
transferring the storage container from the container handling vehicle having a cantilever to the container transport vehicle by:
lowering the first support surface of the elevator assembly;
moving the cantilever of the container handling vehicle carrying the storage container into the internal receiving space through the side opening; and
lowering the storage container onto the first support surface by the container handling vehicle.

44. The method of transferring a storage container according to claim 42 comprising:
transferring the storage container from the container transport vehicle to the container handling vehicle having a cantilever by:
lowering the first support surface of the elevator assembly such that a lower end of a storage container carried by the first support surface extends through the base opening of the vehicle base;
moving the cantilever of the container handling vehicle into the internal receiving space through the side opening; and
picking up the storage container by the container handling vehicle.
